(19) United States
(12) Patent Application Publication
(10) Pub. No.: US 2020/0022245 A1
(43) Pub. Date: Jan. 16, 2020

(54) BAR NOZZLE-TYPE PLASMA TORCH

(71) Applicant: KOREA HYDRO & NUCLEAR POWER CO., LTD., Gyeongsangbuk-do (KR)

(72) Inventors: Hyun Je CHO, Daejeon (KR); Seok Ju HWANG, Daejeon (KR)

(21) Appl. No.: 16/464,948

(22) PCT Filed: Nov. 24, 2017
(86) PCT No.: PCT/KR2017/013506

§ 371 Date: May 29, 2019

(30) Foreign Application Priority Data
Nov. 30, 2016 (KR) 10-2016-0161741

(51) Int. Cl. H05H 1/34

(52) U.S. Cl. CPC H05H 1/3405

(57) ABSTRACT

A bar nozzle-type plasma torch according to an embodiment of the present invention comprises: a bar electrode having a support and an electrode tip connected to one end of the support; and a cylindrical body for generating plasma by means of the electrode tip being inserted into a nozzle electrode having a groove formed therein.

### TECHNICAL FIELD

The present invention relates to a rod-nozzle type plasma torch. More particularly, the present invention relates to a device in which a rod-like body is inserted through a rear electrode and a groove is formed in a nozzle of a front electrode.

### BACKGROUND ART

Torches began being used in the industrial field in 1950s. Since then, they have been extensively used for plasma incineration and melting, and the performance of the torches has steadily improved. In particular, recently, as energy efficiency improvement through non-transferred/transferred dual mode operation has been recognized as an important issue for high-power incineration and melting apparatuses, research on applicability of reverse-polarity plasma torches allowing dual mode operation has been conducted. On the other hand, as for the behavior of anode and cathode spots in a DC plasma torch composed of an anode and a cathode, the anode spot is relatively stationary but the cathode spot is easily displaced in the flow direction depending on the flow rate or electrode structure. Thus, in a conventional reverse-polarity rod-nozzle type plasma torch, an anode spot is immobilized on the surface of a button-shaped rod electrode while a cathode spot can easily be pushed along an open nozzle cathode. Therefore, the length of an arc is increased, and in dual mode operation, it can be easily moved to a base material disposed outside the torch.

The free mobility of the cathode spot is a major cause of axial arc oscillation, resulting in abnormal arcing that occurs anywhere, on the internal surface and the external surface of a nozzle during the non-transferred operation. This serves as a key factor of deterioration of process reliability, which is a chronic problem of reverse-polarity nozzle-nozzle type plasma torches. A conventional method for efficiently controlling such axial arc oscillation has been disclosed. For example, it is a nozzle with a step-shaped internal structure. When the internal structure of the nozzle is step-shaped to be expanded in the direction of the outlet of the nozzle, a fluid forms turbulent regions due to rapid expansion at each stair-step while passing through the nozzle. It is well known that in these turbulent regions, the flow velocity decreases and eddies occur, making the cathode spot stay for a relatively long time, thereby reducing the axial arc oscillation.

However, when the nozzle electrode is designed in a stair form to generate turbulence, it is necessary to make the diameter larger as it goes to the nozzle outlet. In this case, the speed of the plasma jet exiting the torch nozzle decreases, resulting in a radial dispersed effect. Accordingly, there is a disadvantage in that the performance of plasma torches employing step-like nozzles may be adversely affected in the field of material processing such as spray coating and incineration melting, which requires a fast and concentrated high enthalpy plasma jet.

Document of Related Art

Korean Patent No. (as of May 3, 2005)

### DISCLOSURE

### Technical Problem

The present invention has been made to solve the problems occurring in the related art, and an objective of the present invention is to provide a device capable of reducing axial arc oscillations by generating a turbulent region in a nozzle, the device having a structure in which an insertion-type rod-nozzle (electrode tip) is applied to a rear electrode and a groove is formed in a nozzle electrode of a front electrode.

### Technical Solution

In order to achieve the object of the present invention, according to one embodiment, there is provided a rod-nozzle type plasma torch including: a rod electrode including a support base and an electrode tip coupled to an end of the support base; and a cylindrical body including a nozzle electrode with a groove on an inner surface thereof, in which the electrode tip is inserted into the nozzle electrode to generate plasma within the cylindrical body.

Preferably, the electrode tip may be made of tungsten or thorium-doped tungsten and may be detachable.

Preferably, the nozzle electrode is divided into two electrode halves with the groove.

### Advantageous Effects

In the present invention, the rod-nozzle type plasma torch has a nozzle electrode having a turbulence-inducting structure in which an insertion-type rod-nozzle is applied to a rear electrode and a nozzle having a groove formed in an inner surface thereof is applied to a front electrode, thereby suppressing axial arc oscillations. Therefore, it is possible to reduce the axial arc oscillations without increasing the size of a nozzle outlet, thereby maintaining the outlet velocity and temperature distribution of a plasma jet exiting the nozzle.

In addition, a high-speed, high-enthalpy plasma jet can be delivered intensively and safely to a target base material.

### DESCRIPTION OF DRAWINGS

FIG. 1 is a cross-sectional view of a rod-nozzle type plasma torch according to the present invention;

FIG. 2 is a partial cross-sectional view of the rod-nozzle type plasma torch according to the present invention;

FIG. 3 is a graph illustrating the relation between an arc current and an arc voltage according to the nozzle structure;

FIG. 4 is a graph illustrating the relation between an arc current and the oscillation width (standard deviation) of an arc voltage according to the nozzle structure;

FIG. 5 is a graph illustrating a simulation result of a plasma velocity distribution of a nozzle structure according to the present invention; and

FIG. 6 is a graph illustrating a simulation result of a plasma temperature distribution of a nozzle structure according to the present invention.

### BEST MODE

In the following description, the specific structural or functional descriptions for exemplary embodiments according to the concept of the present disclosure are merely for illustrative purposes and those skilled in the art will appreciate that various modifications and changes to the exemplary embodiments are possible, without departing from the scope and spirit of the present invention. Therefore, the present invention is intended to cover not only the exemplary embodiments but also various alternatives, modifications, equivalents, and other embodiments that may be included within the spirit and scope of the embodiments as defined by the appended claims.

Herein below, exemplary embodiments of the present disclosure will be described in detail with reference to the accompanying drawings.

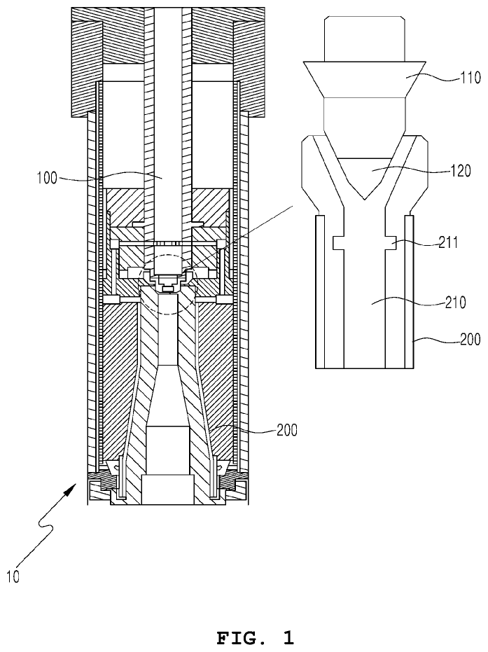

FIG. 1 is a cross-sectional view of a rod-nozzle type plasma torch according to the present invention.

Referring to FIG. 1, the rod-nozzle type plasma torch includes a rod electrode 100 and a cylindrical body 200. The rod electrode 100 is composed of a support base 110 and an electrode tip 120 coupled to one end of the support base 110. The cylindrical body 200 includes a nozzle electrode 210 having a groove 211 formed in an inner surface thereof. The electrode tip 120 is inserted into the nozzle electrode 210, and plasma is generated in the cylindrical body 200.

The electrode tip 120 is made of tungsten or thorium-doped tungsten. The electrode tip 120 is inserted into the nozzle electrode 210. The electrode tip 120 reacts with the nozzle electrode 210 to generate plasma. The tungsten or the thorium-doped tungsten gradually wears while being used for a long time. Therefore, the electrode tip 120 is detachably coupled to the support base 110 so as to be replaceable.

The nozzle electrode 210 is composed of two electrode fractions. When these electrode fractions are face-to-face coupled, the groove 211 is formed. The two electrode fractions are electrically insulated by the groove 211. The groove 211 of the nozzle electrode 210 is a turbulence-inducting member that reduces the flow velocity and causes an eddy region. This makes a cathode spot stay a longer time, thereby reducing the axial arc oscillation.

In addition, in order to form the groove 211 in the nozzle electrode 210, various methods may be used as well as the method described above. That is, two electrodes are coupled via an insulating layer interposed therebetween, or the groove 211 is formed in the nozzle electrode 210 through lathe processing. Various methods can be used if the groove can be formed in the nozzle electrode 210 to generate turbulence.

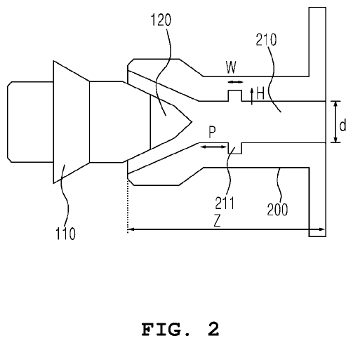

As illustrated in FIG. 2, the nozzle electrode 210 has a nozzle with a diameter of d and the groove 211 having a width of W and a depth of H. The groove 211 is spaced apart from the electrode tip 120 by a distance of P.

To investigate the effect of the groove 211 on the arc oscillation, a test was performed.

In the test, the groove was positioned a distance of 3 mm from the electrode tip. To compare an ordinary cylindrical nozzle and a groove-provided nozzle, the torches having the same size were used. The nozzle diameter d was 7 mm, the groove width W was 2 mm, the groove depth H was 1 mm, and the tip-to-groove distance P was 3 mm.

The operating conditions of the torches were as follows: the hydrogen content is fixed at 20%, the flow rate of a process gas for generation of plasma was 40 to 60 l/min, and an arc current was changed from 500 A to 800 A.

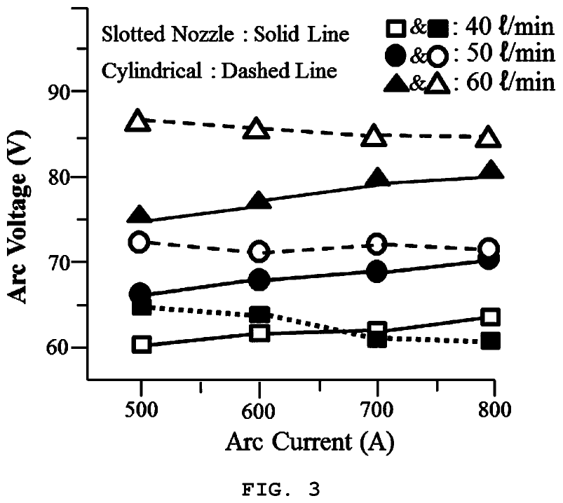

FIG. 3 shows changes in average arc voltage according to arc currents, measured in the groove-provided nozzle and the cylindrical nozzle. The cylindrical nozzle shows that the arc voltage decreases with arc current while the groove-provided nozzle shows that the arc voltage increases with arc current. The arc voltage difference between the two nozzles was about 5 V to 10 V at an arc current of 500 A depending on the flow rate, gradually decreased with current, and was reversed at an arc current of about 800 A.

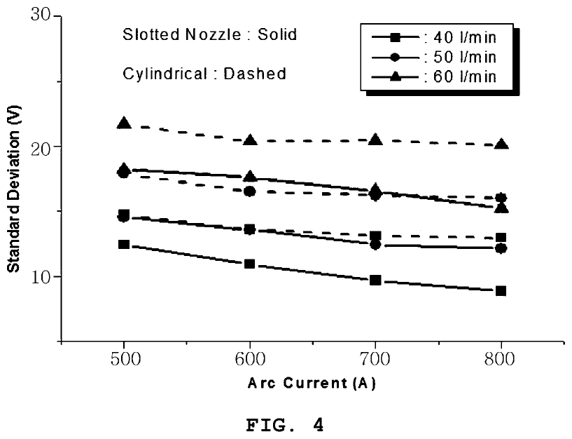

FIG. 4 is a graph showing dynamic changes in arc voltage. FIG. 4 provides a comparison between changes in arc voltage swing width (standard deviation) between the cylindrical nozzle and the groove-provided nozzle. The graph shows that the arc voltage swing width increases with the flow rate of a gas and decreases with an arc current for both of the nozzles.

The test results of FIGS. 3 and 4 show that the groove-provided nozzle offers a steady high output at an arc current of 800 A or higher under the condition of a constant flow rate.

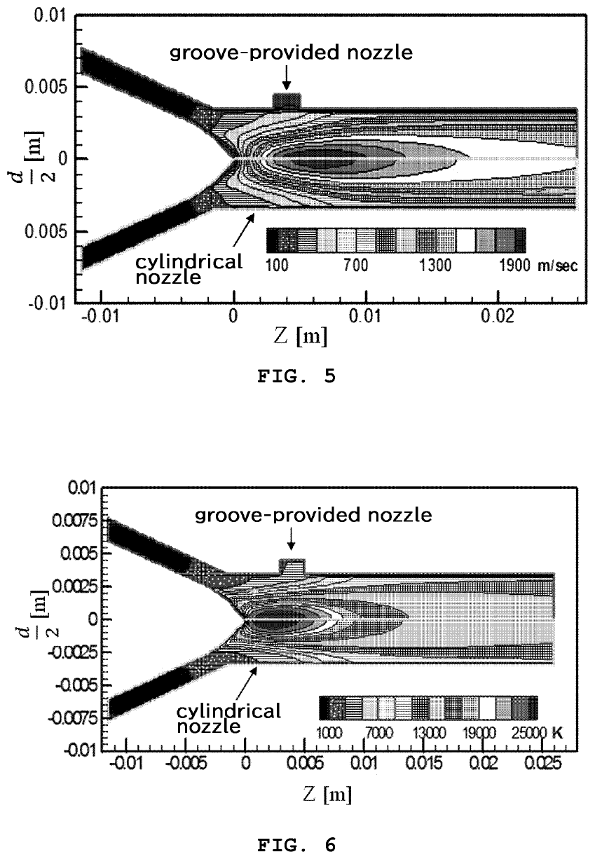

FIGS. 5 and 6 show the effect of the groove formed in the nozzle electrode on the velocity and temperature distribution of a plasma jet.

In the test, the groove was positioned a distance of 3 mm from the electrode tip. To compare an ordinary cylindrical nozzle and a groove-provided nozzle, torches having the same size were used. The nozzle diameter d was 7 mm, the groove width W was 2 mm, the groove depth H was 1 mm, and the electrode tip-to-groove distance P was 3 mm.

The estimated velocity and temperature of a plasma jet was computer-simulated under conditions in which the arc current was 600 A, the flow rate of a process gas was 50 l/min, and an Ar gas with a hydrogen content of 10% was used. FIG. 5 is a graph illustrating comparison results of plasma jet velocities of the cylindrical nozzle torch and the groove-provided nozzle torch. FIG. 6 is a graph illustrating comparison results of plasma jet temperature distributions of the cylindrical nozzle torch and the groove-provided nozzle torch.

The comparison results of FIGS. 5 and 6 show that the groove-provided nozzle has an effect of expanding the plasma velocity and temperature in the axial direction compared to the cylindrical nozzle. That is, unlike the cylindrical nozzle having the same diameter, the groove-provided nozzle exhibits no decrease in the velocity and temperature of a plasma jet at the nozzle outlet.

In conclusion, the groove-provided nozzle has an effect of suppressing the axial arc oscillation without reducing the plasma jet velocity and temperature at the nozzle outlet.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

### EXPLANATION OF REFERENCE NUMERALS

| | |
|---|---|
| 10: Torch | 100: Rod electrode |
| 110: Support base | 120: Electrode tip |
| 200: Cylindrical body | 210: Nozzle electrode |
| 211: Recess | D: Nozzle electrode |
| W: Nozzle width | H: Nozzle depth |

P: Distance between nozzle groove and tip of rod electrode
Z: Nozzle length of front electrode

1. A rod-nozzle type plasma torch comprising:
a rod electrode comprising a support base;
an electrode tip coupled to an end of the support base; and
a cylindrical body;
wherein a nozzle electrode is disposed inside the cylindrical body and has a groove formed in an inner surface thereof,
wherein plasma is generated by inserting the electrode tip into the nozzle electrode.

2. The rod-nozzle type plasma torch of claim 1, wherein the electrode tip, which is detachable from the support base, comprises tungsten or thorium-doped tungsten.

3. The rod-nozzle type plasma torch of claim 1,
wherein the nozzle electrode is divided into two electrode fractions with respect to the groove.
